(19) United States
(12) Patent Application Publication
(10) Pub. No.: US 2025/0084273 A1
(43) Pub. Date: Mar. 13, 2025

(54) UV CURABLE COATINGS SYSTEM FOR IMPROVED SCRATCH RESISTANCE

(71) Applicant: SWIMC LLC, Cleveland, OH (US)

(72) Inventors: Bradley J. WINKLE, Jamestown, NC (US); Christopher BERLINGHOF, High Point, NC (US); Aaron COOPER, Greensboro, NC (US); Randolph G. COX, Greensboro, NC (US); Jigarkumar B. PATEL, Greensboro, NC (US); Kyle PATMORE, Greensboro, NC (US); Christine BOPP, Ludwigsburg (DE); Brian L. BROWN, High Point, NC (US)

(21) Appl. No.: 18/882,839

(22) Filed: Sep. 12, 2024

Related U.S. Application Data
(60) Provisional application No. 63/582,264, filed on Sep. 13, 2023.

(51) Int. Cl. C09D 135/02; C09D 5/00; C09D 7/62

(52) U.S. Cl. CPC C09D 135/02; C09D 5/002; C09D 7/62

(57) ABSTRACT

A coatings system for improved scratch resistance is provided. The coatings system comprises: 1) a primer comprising a difunctional (meth)acrylate ester monomer, a first multifunctional (meth)acrylate, and a first silane-treated aluminum oxide; and 2) a topcoat comprising a difunctional (meth)acrylate ester monomer, a second multifunctional (meth)acrylate, and a second silane-treated aluminum oxide. Further, the coatings system may be UV curable or another type of radiation curable. A method of preparing the coatings system and an article coated with the coatings system are also described.

### FIELD

The present disclosure relates generally to compositions for a coatings system, and, more particularly, a coatings system comprising: 1) a primer comprising a difunctional (meth)acrylate ester monomer, a first multifunctional (meth)acrylate, and a first silane-treated aluminum oxide; and 2) a topcoat comprising a difunctional (meth)acrylate ester monomer, a second multifunctional (meth)acrylate, and a second silane-treated aluminum oxide. Further, the coatings system may be UV curable or another type of radiation curable. A method of preparing the coatings system and an article coated with the coatings system are also described.

### BACKGROUND

More recently, conventional coatings systems have been used in numerous applications, including but not limited to applications over demanding surfaces such as flooring. These surfaces may be wood, plastic (such as vinyl flooring), metal, or composite. Such surfaces must withstand constant use. Performance requirements for these conventional coatings systems may include but are not limited to adhesion, chemical resistance, scratch resistance, mar resistance, abrasion resistance, surface slip, wear resistance, and other testing. The coatings should also be free of surface defects like craters and have excellent adhesion to various substrates. Although certain properties may improve with changes to the coatings formulation, others may suffer due to these modifications.

Manufacturers, especially wood, plastics, electronics, automotive, aerospace, marine, general industrial, and other consumer goods manufacturers, have increasingly demanded for these particular performance requirements for coatings. Manufacturers are continually looking for coatings that exhibit these improved properties, such as chemical resistance, wear resistance, and adhesion without sacrificing other performance properties, such as scratch and abrasion resistance. In view of these challenges with many conventional coatings systems, the need therefore remains for improved coatings that can provide adhesion, scratch resistance, abrasion resistance, and other improved properties as well as other advantages.

### SUMMARY

In accordance with an embodiment of the present invention, a coatings system is provided. The coatings system may comprise: 1) a primer comprising a difunctional (meth)acrylate ester monomer, a first multifunctional (meth)acrylate, and a first silane-treated aluminum oxide; and 2) a topcoat comprising a difunctional (meth)acrylate ester monomer, a second multifunctional (meth)acrylate, and a second silane-treated aluminum oxide. In particular, increasing the concentration of aluminum oxide in both the primer and topcoat may provide improved properties such as scratch resistance over having aluminum oxide in the topcoat alone. In many embodiments, the first silane-treated aluminum oxide comprises fused aluminum oxide, calcined aluminum oxide, or combinations thereof. In many embodiments, the second silane-treated aluminum oxide comprises calcined aluminum oxide, fused aluminum oxide, or combinations thereof.

A further object of the present disclosure is to provide such a coatings system having an improved scratch resistance as measured by ASTM D7027 or BS EN 16094 or CEN/TS 16611:2014.

A further object of the present disclosure is to provide a coating system comprising silane-treated aluminum oxide, where the coatings system can be applied to a variety of substrates, including vinyl flooring, and cured.

A method of preparing the coatings system as well as an article comprising the coatings system is also described herein.

To the accomplishment of the foregoing and related ends, the following description set forth certain illustrative aspects and implementations. These are indicative of a few of the various ways in which one or more aspects may be employed. Other aspects, advantages and novel features of the disclosure will become apparent from the following detailed description when considered.

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

The present disclosure relates generally to coatings systems that provide advantageous improvements over coatings systems. It has been discovered that the use of a particular coating system comprising: 1) a primer comprising a difunctional (meth)acrylate ester monomer, a first multifunctional (meth)acrylate, and a first silane-treated aluminum oxide; and 2) a topcoat comprising a difunctional (meth)acrylate ester monomer, a second multifunctional (meth)acrylate, and a second silane-treated aluminum oxide can surprisingly lead to improved performance properties when used in a coating, namely improved adhesion, chemical resistance, scratch resistance, abrasion resistance, surface slip, and color retention, as well as other advantages. Further, the coatings system described herein provides both a primer and a topcoat that act synergistically to enhance certain properties over conventional coatings systems. In particular, the coatings system described herein provides an improvement for scratch resistance.

### Primer

The primer in the coatings system described herein may be at least partially coated onto a substrate. In many embodiments, at least one substrate comprises wood (including both natural and engineered wood), metal, concrete, paper, ceramic, plastic, composites, or combinations thereof. In some embodiments, a natural wood substrate may include pine (e.g., white pine and southern ponderosa pine), fir, spruce, oak (e.g., white oak and red oak), maple, birch, hickory, walnut, ash, aspen, spruce, cherry, Brazilian cherry, beech, cedar, teak, bamboo, black cherry, alder, wenge, redwood, rosewood, acacia, mahogany, or derivatives thereof (such as veneer). In some embodiments, a wood substrate may include plywood. Engineered wood may include but is not limited to plywood oriented strand board (OSB), medium density fiberboard (MDF), particle board, and composite shiplap. In other embodiments, a wood substrate may include medium-density fiberboard. In yet another embodiment, a wood substrate may include composite materials.

The primer in the coatings system described herein may comprise a difunctional (meth)acrylate ester monomer, a first multifunctional (meth)acrylate, and a first silane-treated aluminum oxide. In many embodiments, the difunctional (meth)acrylate ester monomer is 1,6-hexanediol diacrylate (HDDA), 1,6-hexanediol dimethacrylate (HDDMA), 1,4-butanediol dimethacrylate (BDDMA), 3-methyl-1,5-pentanediol diacrylate (MPDDA), 1,10-decanediol diacrylate (DDDA), tripropylene glycol diacrylate (TPGDA), dipropylene glycol diacrylate (DPGDA), triethylene glycol diacrylate (TEGDA), polyethylene glycol diacrylate, neopentyl glycol methacrylate (NPGMA), ethylene glycol dimethacrylate (EGDMA), diethylene glycol dimethacrylate (DEGMA), triethylene glycoldimethacrylate (TEGDMA), tetraethylene glycoldimethacrylate (T4EGDMA), hydroxy pivalic acid neopentyl glycol diacrylate (HPNDA), aliphatic difunctional urethane (meth)acrylate, aromatic difunctional urethane (meth)acrylate, difunctional polyester (meth)acrylate, or combinations thereof.

In many embodiments, the difunctional (meth)acrylate ester monomer ranges from 5% by weight to 50% by weight of the primer. In some embodiments, the difunctional (meth)acrylate ester monomer ranges from 10% to 50% by weight of the primer. In other embodiments, the difunctional (meth)acrylate ester monomer can, for example, range from 5% to 45%, from 5% to 40%, from 5% to 35%, from 5% to 30%, from 5% to 25%, from 5% to 20%, from 5% to 15%, from 10% to 45%, from 10% to 40%, from 10% to 35%, from 10% to 30%, from 10% to 25%, from 10% to 20%, from 10% to 15%, from 15% to 50%, from 15% to 45%, from 15% to 40%, from 15% to 35%, from 15% to 30%, from 15% to 25%, from 15% to 20%, from 20% to 50%, from 20% to 45%, from 20% to 40%, from 20% to 35%, from 20% to 30%, from 20% to 25%, from 25% to 50%, from 25% to 45%, from 25% to 40%, from 25% to 35%, from 25% to 30%, from 30% to 50%, from 30% to 45%, from 30% to 40%, from 30% to 35%, from 35% to 50%, from 35% to 45%, from 35% to 40%, from 40% to 50%, and from 40% to 45%. Other ranges are also contemplated.

In many embodiments, the first multifunctional (meth)acrylate is at least trifunctional. In one embodiment, the first multifunctional (meth)acrylate is trifunctional. In one embodiment, the first multifunctional (meth)acrylate is tetrafunctional. In one embodiment, the first multifunctional (meth)acrylate is hexafunctional. In some embodiments, the first multifunctional (meth)acrylate is dimethylolpropane triacrylate (TMPTA), pentaerythritol triacrylate (PETA), trimethylolpropane triacrylate (TMPTA), trimethylolpropane trimethacrylate (TMPTMA), pentaerythritol tetraacryate (PETTA), dipentaerythritol pentaacryate (DiPETA), dipentaerythritol hexaacryate (DPHA), aliphatic trifunctional urethane (meth)acrylate, aromatic trifunctional urethane (meth)acrylate, aliphatic tetrafunctional urethane (meth)acrylate, aromatic tetrafunctional urethane (meth)acrylate, aliphatic hexafunctional urethane (meth)acrylate, aromatic hexafunctional urethane (meth)acrylate, trifunctional polyester (meth)acrylate, tetrafunctional polyester (meth)acrylate, hexafunctional polyester (meth)acrylate, or combinations thereof. Other multifunctional (meth)acrylates are also contemplated. In yet other embodiment, the first multifunctional (meth)acrylate has at least 7 functionalities. In another embodiment, the first multifunctional (meth)acrylate has at least 8 functionalities. In still another embodiment, the first multifunctional (meth)acrylate has at least 9 functionalities. In one embodiment, the first multifunctional (meth)acrylate is dendritic. In one embodiment in which the first multifunctional (meth)acrylate is dendritic, the dendrite has a high functionality.

In many embodiments, the first multifunctional (meth)acrylate ranges from 10% by weight to 50% by weight of the primer. In many embodiments, the first multifunctional (meth)acrylate ranges from 10% by weight to 40% by weight of the primer. In other embodiments, the first multifunctional (meth)acrylate can, for example, range from 10% to 45%, from 10% to 40%, from 10% to 35%, from 10% to 30%, from 10% to 25%, from 10% to 20%, from 10% to 15%, from 15% to 50%, from 15% to 45%, from 15% to 40%, from 15% to 35%, from 15% to 30%, from 15% to 25%, from 15% to 20%, from 20% to 50%, from 20% to 45%, from 20% to 40%, from 20% to 35%, from 20% to 30%, from 20% to 25%, from 25% to 50%, from 25% to 45%, from 25% to 40%, from 25% to 35%, from 25% to 30%, from 30% to 50%, from 30% to 45%, from 30% to 40%, from 30% to 35%, from 35% to 50%, from 35% to 45%, from 35% to 40%, from 40% to 50%, and from 40% to 45%. Other ranges are also contemplated.

In many embodiments, the first silane-treated aluminum oxide comprises fused aluminum oxide, calcined aluminum oxide, or a combination thereof. Fused aluminum oxide is a particular type of aluminum oxide that is harder than other types of aluminum oxide (measured as 9.0 on Mohs scale). In some embodiments, the fused aluminum oxide, calcined aluminum oxide, or a combination thereof ranges from 8 microns to 50 microns. In other embodiments, the first silane-treated aluminum oxide can, for example, range from 10 microns to 50 microns, from 10 microns to 45 microns, from 10 microns to 40 microns, from 10 microns to 35 microns, from 10 microns to 30 microns, from 10 microns to 25 microns, from 15 microns to 50 microns, from 15 microns to 45 microns, from 15 microns to 40 microns, from 15 microns to 35 microns, from 15 microns to 30 microns, from 15 microns to 25 microns, from 20 microns to 50 microns, from 20 microns to 45 microns, from 20 microns to 40 microns, from 20 microns to 35 microns, from 20 microns to 30 microns, from 20 microns to 25 microns, from 25 microns to 50 microns, from 25 microns to 45 microns, from 25 microns to 40 microns, from 25 microns to 35 microns, from 25 microns to 30 microns, from 30 microns to 50 microns, from 30 microns to 45 microns, from 30 microns to 40 microns, from 30 microns to 35 microns, from 35 microns to 50 microns, from 35 microns to 45 microns, and from 40 microns to 50 microns, Other ranges are also contemplated. In many embodiments, the fused aluminum oxide is white aluminum oxide. Not to be bound by theory, fused aluminum oxide, calcined aluminum oxide, or a combination thereof may at least partially be located at the surface or above the surface of the primer. Due to this orientation, the fused aluminum oxide, calcined aluminum oxide, or a combination thereof in the primer may synergistically enhance certain properties of the topcoat, including scratch resistance. Further, the surface location may also enhance the coefficient of friction due to a larger particle size.

In many embodiments, the first silane-treated aluminum oxide is at least 5% by weight of the primer. In some embodiments, the first silane-treated aluminum oxide is at least 10% by weight of the primer. In many embodiments, the first silane-treated aluminum oxide is at least 15% by weight of the primer. In many embodiments, the first silane-treated aluminum oxide is at least 20% by weight of the primer. In some embodiments, the first silane-treated aluminum oxide comprises 5% to 60% by weight of the primer. In other embodiments, the first silane-treated aluminum oxide can, for example, range from 5% to 55%, from 5% to 50%, from 5% to 45%, from 5% to 40%, from 5% to 35%, from 5% to 30%, from 5% to 25%, from 5% to 20%, from 5% to 15%, from 10% to 60%, from 10% to 55%, from 10% to 50%, from 10% to 45%, from 10% to 40%, from 10% to 35%, from 10% to 30%, from 10% to 25%, from 10% to 20%, from 10% to 15%, from 15% to 60%, from 15% to 55%, from 15% to 50%, from 15% to 45%, from 15% to 40%, from 15% to 35%, from 15% to 30%, from 15% to 25%, from 15% to 20%, from 20% to 60%, from 20% to 55%, from 20% to 50%, from 20% to 45%, from 20% to 40%, from 20% to 35%, from 20% to 30%, from 20% to 25%, from 25% to 60%, from 25% to 55%, from 25% to 50%, from 25% to 45%, from 25% to 40%, from 25% to 35%, from 25% to 30%, from 30% to 60%, from 30% to 55%, from 30% to 50%, from 30% to 45%, from 30% to 40%, from 30% to 35%, from 35% to 60%, from 35% to 55%, from 35% to 50%, from 35% to 45%, from 35% to 40%, from 40% to 60%, from 40% to 55%, from 40% to 50%, and from 40% to 45%. Other ranges are also contemplated.

### Topcoat

The topcoat of the coatings system described herein may comprise a difunctional (meth)acrylate ester monomer, a second multifunctional (meth)acrylate, and a second silane-treated aluminum oxide. In many embodiments, the second multifunctional (meth)acrylate is at least trifunctional. In one embodiment, the second multifunctional (meth)acrylate is trifunctional. In one embodiment, the second multifunctional (meth)acrylate is tetrafunctional. In one embodiment, the second multifunctional (meth)acrylate is hexafunctional. In some embodiments, the second multifunctional (meth)acrylate is trimethylolpropane triacrylate (TMPTA), pentaerythritol triacrylate (PETA), trimethylolpropane triacrylate (TMPTA), trimethylolpropane trimethacrylate (TMPTMA), pentaerythritol tetraacryate (PETTA), dipentaerythritol pentaacryate (DiPETA), dipentaerythritol hexaacryate (DPHA), aliphatic trifunctional urethane (meth)acrylate, aromatic trifunctional urethane (meth)acrylate, aliphatic tetrafunctional urethane (meth)acrylate, aromatic tetrafunctional urethane (meth)acrylate, aliphatic hexafunctional urethane (meth)acrylate, aromatic hexafunctional urethane (meth)acrylate, trifunctional polyester (meth)acrylate, tetrafunctional polyester (meth)acrylate, hexafunctional polyester (meth)acrylate, or combinations thereof. Other multifunctional (meth)acrylates are also contemplated. In yet other embodiment, the second multifunctional (meth)acrylate has at least 7 functionalities. In another embodiment, the second multifunctional (meth)acrylate has at least 8 functionalities. In still another embodiment, the second multifunctional (meth)acrylate has at least 9 functionalities. In one embodiment, the second multifunctional (meth)acrylate is dendritic. In one embodiment in which the second multifunctional (meth)acrylate is dendritic, the dendrite has a high functionality. In many embodiments, the second multifunctional (meth)acrylate ranges from 5% by weight to 50% by weight of the primer. In many embodiments, the second multifunctional (meth)acrylate ranges from 10% by weight to 40% by weight of the primer. In other embodiments, the second multifunctional (meth)acrylate can, for example, range from 10% to 45%, from 10% to 40%, from 10% to 35%, from 10% to 30%, from 10% to 25%, from 10% to 20%, from 10% to 15%, from 15% to 50%, from 15% to 45%, from 15% to 40%, from 15% to 35%, from 15% to 30%, from 15% to 25%, from 15% to 20%, from 20% to 50%, from 20% to 45%, from 20% to 40%, from 20% to 35%, from 20% to 30%, from 20% to 25%, from 25% to 50%, from 25% to 45%, from 25% to 40%, from 25% to 35%, from 25% to 30%, from 30% to 50%, from 30% to 45%, from 30% to 40%, from 30% to 35%, from 35% to 50%, from 35% to 45%, from 35% to 40%, from 40% to 50%, and from 40% to 45%. Other ranges are also contemplated

In many embodiments, the second silane-treated aluminum oxide comprises calcined aluminum oxide, fused aluminum oxide, or combinations thereof. Calcined aluminum oxide may have a platy shape and a hardness value of 9.0 (Mohs scale). In some embodiments, the calcined aluminum oxide fused aluminum oxide, or combinations thereof ranges from 3 microns to 20 microns. In other embodiments, the second silane-treated aluminum oxide can, for example, range from 3 microns to 18 microns, from 3 microns to 15 microns, from 3 microns to 13 microns, from 3 microns to 10 microns, from 3 microns to 8 microns, from 5 microns to 20 microns, from 5 microns to 18 microns, from 5 microns to 15 microns, from 5 microns to 13 microns, from 5 microns to 10 microns, from 5 microns to 8 microns, from 7 microns to 20 microns, from 7 microns to 18 microns, from 7 microns to 15 microns, from 7 microns to 13 microns, from 7 microns to 10 microns, from 10 microns to 20 microns, from 10 microns to 18 microns, from 10 microns to 15 microns, from 10 microns to 13 microns, from 12 microns to 20 microns, from 12 microns to 15 microns, and from 15 microns to 20 microns. Other ranges are also contemplated. In some embodiments, the second silane-treated aluminum oxide may comprise fused aluminum oxide, calcined aluminum oxide, or a combination thereof. In one embodiment, the fused aluminum oxide, calcined aluminum oxide, or a combination thereof particle may range from 8 microns to 30 microns. In one embodiment, the second silane-treated aluminum oxide may be a calcined grade aluminum oxide. Not to be bound by theory, the larger size particles of the first silane-treated aluminum oxide may protrude into topcoat where these platy particles in topcoat may minimize roughness while maintaining scratch resistance.

In many embodiments, the second silane-treated aluminum oxide is at least 5% by weight of the topcoat. In some embodiments, the second silane-treated aluminum oxide is at least 10% by weight of the topcoat. In many embodiments, the second silane-treated aluminum oxide is at least 15% by weight of the topcoat. In many embodiments, the second silane-treated aluminum oxide is at least 20% by weight of the topcoat. In some embodiments, the first silane-treated aluminum oxide comprises 5% to 30% by weight of the primer. In other embodiments, the first silane-treated aluminum oxide can, for example, range from 5% to 25%, from 5% to 20%, from 5% to 15%, from 10% to 30%, from 10% to 25%, from 10% to 20%, from 10% to 15%, from 15% to 30%, from 15% to 25%, from 15% to 20%, from 20% to 30%, from 20% to 25%, and from 25% to 30%. Other ranges are also contemplated.

In some embodiments, the first silane-treated aluminum oxide in the primer and the second silane-treated aluminum oxide in the topcoat are different silane-treated aluminum oxides. In some embodiments, the first silane-treated aluminum oxide in the primer and the second silane-treated aluminum oxide in the topcoat are the same silane-treated aluminum oxide.

In many embodiments, the coatings system described herein may further comprise at least one: other polymer or polymer dispersion, solvent, biocide, mildewcide, algaecide, leveling agent, anti-settling agent, pH buffer, corrosion inhibitor, drier, anti-skinning agent, anti-cratering agent, anti-sag agent, heat stabilizer, UV absorber/inhibitor, HALS (hindered amine light stabilizer), antioxidant, wetting agent, flatteners and other inert pigments (such as titanium dioxide, dyes, clay, amorphous and surface treated silica, calcium carbonate, and the like, and combinations thereof), flow agent, catalyst, flow aid, anti-corrosive agent, adhesion promotor, toughening agent, or combinations thereof. Other materials are also contemplated.

In many embodiments, the coatings system described herein may further comprise at least one additional primer coated onto the primer. Not to be bound by theory, additional primers may improve certain properties, including but not limited to scratch resistance. In one embodiment, at least one additional primer may be partially coated onto the primer.

In many embodiments, the coatings system described herein may further comprise at least one additional topcoat coated onto the topcoat. Not to be bound by theory, additional topcoats may improve certain properties, including but not limited to enhanced flow and appearance as well as a soft feel. In one embodiment, at least one additional topcoat may be partially coated onto the topcoat.

In many embodiments, the coatings system described herein may further comprise at least one clear coat coated on the topcoat or at least one additional topcoat. At least one clear coat may be used to further protect the coatings system, particularly for scratch resistance, wear resistance, and color retention as well as other advantage. These advantages may include but are not limited to improved stain and chemical resistance as well as coatings appearance.

Further, the coatings system may be ultraviolet (UV) curable or another type of radiation curable. In many embodiments, the coatings system described herein cured by UV, electron beam, heat, or combinations thereof. In some embodiments, the coatings system described herein is cured by ultraviolet (UV), electron beam, infrared, heat, or combinations thereof.

Also described herein is a method of preparing the coatings system described, where the coating system comprises: 1) a primer comprising a difunctional (meth)acrylate ester monomer, a first multifunctional (meth)acrylate, and a first silane-treated aluminum oxide; and 2) a topcoat comprising a difunctional (meth)acrylate ester monomer, a second multifunctional (meth)acrylate, and a second silane-treated aluminum oxide.

Also described herein is an article comprising the coatings system described, where the coating system comprises: 1) a primer comprising a difunctional (meth)acrylate ester monomer, a first multifunctional (meth)acrylate, and a first silane-treated aluminum oxide; and 2) a topcoat comprising a difunctional (meth)acrylate ester monomer, a second multifunctional (meth)acrylate, and a second silane-treated aluminum oxide. The article may be coated with the coatings system described herein. The article may be comprised of substrate which may include but is not limited to metal, plastics, wood (including both natural and engineered wood), glass, metal, concrete, paper, ceramic, plastic, composites, or combinations thereof. In some embodiments, a natural wood substrate may include pine (e.g., white pine and southern ponderosa pine), fir, spruce, oak (e.g., white oak and red oak), maple, birch, hickory, walnut, ash, aspen, spruce, cherry, Brazilian cherry, beech, cedar, teak, bamboo, black cherry, alder, wenge, redwood, rosewood, acacia, mahogany, or derivatives thereof (such as veneer). In some embodiments, a wood substrate may include plywood. Engineered wood may include but is not limited to plywood oriented strand board (OSB), medium density fiberboard (MDF), particle board, and composite shiplap. In other embodiments, a wood substrate may include medium-density fiberboard. In yet another embodiment, a wood substrate may include composite materials

### Data

Table 1 provides a model formula for the primer of the coatings system described herein:

TABLE 1
Primer Model Formula

| | Range | Preferred Range |
|---|---|---|
| Primer | (% by weight) | (% by weight) |
| 1,6-hexanediol diacrylate | 15-40 | 25-35 |
| (HDDA) | | |
| dipentaerythritol pentaacryate | 10-30 | 20-30 |
| (DiPETA) and/or | | |
| hexafunctional aromatic | | |
| urethane (meth)acrylate | | |
| Silicone copolymer | 0.1-5 | 0.1-2 |
| Rheology additive | 0.1-2.0 | 0.5-1.0 |
| Defoamer | 0.1-2.0 | 0.1-1.0 |
| Silane-treated aluminum oxide - | 5-60 | 20-50 |
| fused | | |
| Solvent | 0-10 | 0-5 |

Table 2 provides a model formula for the topcoat of the coatings system described herein:

TABLE 2
Topcoat Model Formula

| | Range | Preferred Range |
|---|---|---|
| Topcoat | (% by weight) | (% by weight) |
| 1,6-hexanediol diacrylate | 20-40 | 25-35 |
| (HDDA) | | |
| dipentaerythritol pentaacryate | 10-30 | 15-25 |
| (DiPETA) | | |
| Hexafunctional aromatic | 5-20 | 5-15 |
| urethane (meth)acrylate | | |
| Silicone copolymer | 0.1-5 | 0.1-2 |
| Silane-treated aluminum oxide - | 5-30 | 5-20 |
| calcined | | |
| Rheology additive | 0.1-2.0 | 0.5-1.0 |
| Defoamer | 0.1-2.0 | 0.1-1.0 |
| Dispersant | 1-10 | 2-8 |
| Matting agent | 5-20 | 5-15 |
| Amorphous silica | 1-10 | 2-8 |
| Solvent | 0-10 | 0-7 |

Table 3 provides details as to the primer formulas used and application properties.

TABLE 3
Primers tested
Test Variables

| | | | | | | | Thickness in mils (measured by ASTM D4138-07a (2022) | | | | | |
|---|---|---|---|---|---|---|---|---|---|---|---|---|
| | Aluminium | | | Post | | Sample | Primer | Primer | Topcoat | Topcoat | Total | Total |
| Primer | Oxide | Amount | Resin | Addition | Topcoat | ID | Target | Actual | Target | Actual | Target | Actual |
| A | [symbol] | 40% | 20.2% | | DiPETA/ | A | 0.54 | 0.52 | 0.44 | 0.54 | 0.98 | 1.06 |
| | | | Pentafunctional | | Urethane | | | | | | | |
| | | | acrylate | | acrylate | | | | | | | |
| | | | 25% Difunctional | | coating | | | | | | | |
| | | | acrylate | | | | | | | | | |
| B | [symbol] | 40% | 20.2% | | | B | 0.54 | 0.52 | 0.44 | 0.46 | 0.98 | 0.98 |
| | | | Hexafunctional | | | | | | | | | |
| | | | acrylate | | | | | | | | | |
| | | | 25% difunctional | | | | | | | | | |
| | | | acrylate | | | | | | | | | |
| C | [symbol] | 40% | 33.2% | | | C | 0.54 | 0.54 | 0.44 | 0.44 | 0.98 | 0.98 |
| | | | Hexafunctional | | | | | | | | | |
| | | | acrylate | | | | | | | | | |
| | | | 12% difunctional | | | | | | | | | |
| | | | acrylate | | | | | | | | | |
| D | [symbol] | 40% | 33.2% | | | D | 0.54 | 0.52 | 0.44 | 0.42 | 0.98 | 0.94 |
| | | | Pentafunctional | | | | | | | | | |
| | | | acrylate | | | | | | | | | |
| | | | 12% difunctional | | | | | | | | | |
| | | | acrylate | | | | | | | | | |
| E | [symbol] | 40% | 39.2% | | | E | 0.54 | 0 | 0.44 | 0 | 0.98 | 0 |
| | | | Hexafunctional | | | | | | | | | |
| | | | acrylate | | | | | | | | | |
| | | | 6% difunctional | | | | | | | | | |
| | | | acrylate | | | | | | | | | |
| F | [symbol] | 40% | 16.6% | | | F | 0.54 | 0.52 | 0.44 | 0.44 | 0.98 | 0.96 |
| | | | Pentafunctional | | | | | | | | | |
| | | | acrylate | | | | | | | | | |
| | | | 16.6% | | | | | | | | | |
| | | | hexafunctional | | | | | | | | | |
| | | | acrylate | | | | | | | | | |
| | | | 12% difunctional | | | | | | | | | |
| | | | acrylate | | | | | | | | | |
| G | [symbol] | 40% | 20.2% | | | G | 0.54 | 0.52 | 0.44 | 0.44 | 0.98 | 0.96 |
| | | | Hexafunctional | | | | | | | | | |
| | | | acrylate | | | | | | | | | |
| | | | 13% | | | | | | | | | |
| | | | Tetrafunctional | | | | | | | | | |
| | | | acrylate | | | | | | | | | |
| | | | 12% difunctional | | | | | | | | | |
| | | | acrylate | | | | | | | | | |
| H | [symbol] | 40% | 20.2% | 3% Silane | | H | 0.54 | 0.5 | 0.44 | 0.5 | 0.98 | 1 |
| | | | Pentafunctional | Treatment | | | | | | | | |
| | | | acrylate | | | | | | | | | |
| | | | 25% difunctional | | | | | | | | | |
| | | | acrylate | | | | | | | | | |
| I | [symbol] | 35% | 20.2% | | | I | 0.51 | 0.48 | 0.44 | 0.46 | 0.95 | 0.94 |
| | | | Pentafunctional | | | | | | | | | |
| | | | acrylate | | | | | | | | | |
| | | | 25% difunctional | | | | | | | | | |
| | | | acrylate | | | | | | | | | |
| J | [symbol] | 30% | 20.2% | | | J | 0.48 | 0.46 | 0.44 | 0.50 | 0.92 | 0.96 |
| | | | Pentafunctional | | | | | | | | | |
| | | | acrylate | | | | | | | | | |
| | | | 25% difunctional | | | | | | | | | |
| | | | acrylate | | | | | | | | | |
| K | [symbol] | 25% | 20.2% | | | K | 0.46 | 0.46 | 0.44 | 0.44 | 0.90 | 0.9 |
| | | | Pentafunctional | | | | | | | | | |
| | | | acrylate | | | | | | | | | |
| | | | 25% difunctional | | | | | | | | | |
| | | | acrylate | | | | | | | | | |
| L | [symbol] | 20% | 20.2% | | | L | 0.44 | 0.46 | 0.44 | 0.44 | 0.88 | 0.9 |
| | | | Pentafunctional | | | | | | | | | |
| | | | acrylate | | | | | | | | | |
| | | | 25% difunctional | | | | | | | | | |
| | | | acrylate | | | | | | | | | |
| M | [symbol] | 15% | 20.2% | | | M | 0.43 | 0.42 | 0.44 | 0.48 | 0.87 | 0.9 |
| | | | Pentafunctional | | | | | | | | | |
| | | | acrylate | | | | | | | | | |
| | | | 25% difunctional | | | | | | | | | |
| | | | acrylate | | | | | | | | | |
| N | Control | | | | | N | 0.46 | 0.46 | 0.44 | 0.46 | 0.90 | 0.92 |

[symbol]

indicates data missing or illegible when filed

In Table 4 below, the samples A-N were compared using scratch resistance and gloss readings.

TABLE 4
Results

| | | | | Scratch | | | | | | | |
|---|---|---|---|---|---|---|---|---|---|---|---|
| | | | | Resistance | | | | | | | |
| | Scratch | Scratch | Scratch | Reading | | | | | | | |
| | Resistance | Resistance | Resistance | Rating | | | | | AVERAGE | | |
| Variables | Rating 1 | Rating 2 | Rating 3 | Average | Gloss 60 | St Dev | Gloss 85 | St Dev | Gloss 60 | Gloss 85 | Scratch |
| A1 | 3 | 4 | 3 | 3.3 | 6.7 | 2.1 | 12.4 | 2.8 | 6 | 11.3 | 2.9 |
| A2 | 3 | 3 | 3 | 3.0 | 5.7 | 0.9 | 10.6 | 1.3 | | | |
| A3 | 2 | 3 | 2 | 2.3 | 5.6 | 1 | 10.8 | 1.5 | | | |
| B1 | 4 | 4 | 4 | 4.0 | 5.7 | 0.8 | 12 | 1 | 6 | 12.2 | 3.7 |
| B2 | 4 | 4 | 4 | 4.0 | 6.5 | 2.7 | 12.7 | 1.9 | | | |
| B3 | 3 | 3 | 3 | 3.0 | 5.8 | 1.3 | 11.9 | 1.5 | | | |
| C1 | 4 | 4 | 3 | 3.7 | 8.1 | 1.8 | 13.4 | 2 | 7.1 | 12.4 | 3.7 |
| C2 | 4 | 3 | 3 | 3.3 | 6.8 | 1.7 | 12.6 | 1.4 | | | |
| C3 | 4 | 4 | 4 | 4.0 | 6.4 | 1.3 | 11.2 | 0.6 | | | |
| D1 | 5 | 5 | 5 | 5.0 | 6.1 | 0.7 | 13.1 | 1.4 | 7.4 | 14.3 | 5.0 |
| D2 | 5 | 5 | 5 | 5.0 | 7.4 | 1.8 | 13.1 | 3.5 | | | |
| D3 | 5 | 5 | 5 | 5.0 | 8.6 | 2.4 | 16.7 | 3 | | | |
| F1 | 5 | 5 | 5 | 5.0 | 6.2 | 0.7 | 12.6 | 2.0 | 6.9 | 13.9 | 4.0 |
| F2 | 5 | 5 | 5 | 5.0 | 7.8 | 0.7 | 15.6 | 1.2 | | | |
| F3 | 2 | 2 | 2 | 2.0 | 6.7 | 1.7 | 13.6 | 3.3 | | | |
| G1 | 3 | 2 | 3 | 2.7 | 8.5 | 2 | 13.9 | 2.6 | 7.1 | 13.0 | 2.7 |
| G2 | 3 | 3 | 3 | 3.0 | 6.4 | 0.7 | 12.5 | 1.4 | | | |
| G3 | 3 | 2 | 2 | 2.3 | 6.4 | 1.3 | 12.6 | 0.9 | | | |
| H1 | 4 | 4 | 5 | 4.3 | 7.7 | 1.8 | 16.1 | 2.5 | 8.3 | 16.4 | 4.1 |
| H2 | 5 | 3 | 5 | 4.3 | 8.6 | 4 | 16.2 | 5 | | | |
| H3 | 3 | 4 | 4 | 3.7 | 8.6 | 3.3 | 16.8 | 3.8 | | | |
| I1 | 5 | 5 | 5 | 5.0 | 7 | 2.4 | 14.6 | 2.7 | 7.1 | 15.0 | 4.6 |
| I2 | 5 | 5 | 5 | 5.0 | 6.9 | 1.9 | 14.6 | 2.2 | | | |
| I3 | 4 | 3 | 4 | 3.7 | 7.4 | 2.1 | 15.7 | 2.6 | | | |
| J1 | 5 | 5 | 5 | 5.0 | 6 | 0.6 | 14 | 1.4 | 6 | 14.0 | 3.4 |
| J2 | 3 | 3 | 3 | 3.0 | 5.8 | 1.4 | 14.1 | 2.2 | | | |
| J3 | 3 | 2 | 2 | 2.3 | 6.2 | 0.8 | 13.9 | 3.1 | | | |
| K1 | 3 | 4 | 4 | 3.7 | 6.7 | 1.5 | 15.9 | 3.1 | 6.1 | 15.1 | 3.9 |
| K2 | 4 | 4 | 4 | 4.0 | 6.2 | 0.6 | 14.8 | 0.7 | | | |
| K3 | 4 | 4 | 4 | 4.0 | 5.4 | 0.7 | 14.5 | 1.2 | | | |
| L1 | 4 | 4 | 4 | 4.0 | 6.6 | 3.8 | 15.4 | 6.6 | 5.9 | 14.1 | 4.1 |
| L2 | 4 | 4 | 3 | 3.7 | 5.8 | 2.2 | 13.7 | 2.7 | | | |
| L3 | 5 | 4 | 5 | 4.7 | 5.2 | 1.1 | 13.1 | 1.6 | | | |
| M1 | 4 | 3 | 3 | 3.3 | 7.2 | 4.1 | 14.4 | 5.2 | 6.5 | 14.8 | 4.1 |
| M2 | 4 | 4 | 5 | 4.3 | 6.2 | 2.3 | 15.4 | 3.7 | | | |
| M3 | 4 | 5 | 5 | 4.7 | 6 | 2.2 | 14.5 | 3 | | | |
| N1 | 4 | 5 | 5 | 4.7 | 7.3 | 1.6 | 12.4 | 3.4 | 7.0 | 12.2 | 4.9 |
| N2 | 5 | 5 | 5 | 5.0 | 6.6 | 1.4 | 11.2 | 1.7 | | | |
| N3 | 5 | 5 | 5 | 5.0 | 7 | 1.8 | 13 | 2.1 | | | |

For the testing provided in Table 4, performance testing for these coatings included 60° gloss and 85° gloss (as measured by ASTM D523). Scratch resistance was measured by an abrasion tester such as a Martindale tester using EN 16094 where 1 is the best (referred to as MSR-A1) and 5 is the worst (referred to as MSR-A5 in EN 16094).

Based on the data in Table 4, the scratch resistance was improved for most primers over the control sample N as well as sample H. Further, higher concentrations of increased particle size particles (360 grit and roughly 23 μm in size) may increase system scratch resistance performance as well as provide a better clarity to the coating.

### Embodiments

The following embodiments are contemplated. All combinations of features and embodiments are contemplated.

Embodiment 1. A coatings system comprising: 1) a primer comprising a difunctional (meth)acrylate ester monomer, a first multifunctional (meth)acrylate, and a first silane-treated aluminum oxide; and 2) a topcoat comprising a difunctional (meth)acrylate ester monomer, a second multifunctional (meth)acrylate, and a second silane-treated aluminum oxide.

Embodiment 2. An embodiment of Embodiment 1, wherein the difunctional (meth)acrylate ester monomer is 1,6-hexanediol diacrylate (HDDA), 1,6-hexanediol dimethacrylate (HDDMA), 1,4-butanediol dimethacrylate (BDDMA), 3-methyl-1,5-pentanediol diacrylate (MPDDA), 1,10-decanediol diacrylate (DDDA), tripropylene glycol diacrylate (TPGDA), dipropylene glycol diacrylate (DPGDA), triethylene glycol diacrylate (TEGDA), polyethylene glycol diacrylate, neopentyl glycol methacrylate (NPGMA), ethylene glycol dimethacrylate (EGDMA), diethylene glycol dimethacrylate (DEGMA), triethylene glycoldimethacrylate (TEGDMA), tetraethylene glycoldimethacrylate (T4EGDMA), hydroxy pivalic acid neopentyl glycol diacrylate (HPNDA), aliphatic difunctional urethane (meth)acrylate, aromatic difunctional urethane (meth)acrylate, difunctional polyester (meth)acrylate, or combinations thereof.

Embodiment 3. An embodiment of any of Embodiments 1-2, wherein the first multifunctional (meth)acrylate is at least trifunctional.

Embodiment 4. An embodiment of any of Embodiments 1-3, wherein the first multifunctional (meth)acrylate is dimethylolpropane triacrylate (TMPTA), pentaerythritol triacrylate (PETA), trimethylolpropane triacrylate (TMPTA), trimethylolpropane trimethacrylate (TMPTMA), pentaerythritol tetraacryate (PETTA), dipentaerythritol pentaacryate (DiPETA), dipentaerythritol hexaacryate (DPHA), aliphatic trifunctional urethane (meth)acrylate, aromatic trifunctional urethane (meth)acrylate, aliphatic tetrafunctional urethane (meth)acrylate, aromatic tetrafunctional urethane (meth)acrylate, aliphatic hexafunctional urethane (meth)acrylate, aromatic hexafunctional urethane (meth)acrylate, trifunctional polyester (meth)acrylate, tetrafunctional polyester (meth)acrylate, hexafunctional polyester (meth)acrylate, or combinations thereof.

Embodiment 5. An embodiment of any of Embodiments 1-4, wherein the first silane-treated aluminum oxide comprises fused aluminum oxide, calcined aluminum oxide, or a combination thereof.

Embodiment 6. An embodiment of any of Embodiments 1-5, wherein the first silane-treated aluminum oxide is at least 5% by weight of the primer.

Embodiment 7. An embodiment of any of Embodiments 1-6, wherein the second multifunctional (meth)acrylate is at least trifunctional.

Embodiment 8. An embodiment of any of Embodiments 1-7, wherein the second multifunctional (meth)acrylate is dimethylolpropane triacrylate (TMPTA), pentaerythritol triacrylate (PETA), trimethylolpropane triacrylate (TMPTA), trimethylolpropane trimethacrylate (TMPTMA), pentaerythritol tetraacryate (PETTA), dipentaerythritol pentaacryate (DiPETA), dipentaerythritol hexaacryate (DPHA), aliphatic trifunctional urethane (meth)acrylate, aromatic trifunctional urethane (meth)acrylate, aliphatic tetrafunctional urethane (meth)acrylate, aromatic tetrafunctional urethane (meth)acrylate, aliphatic hexafunctional urethane (meth)acrylate, aromatic hexafunctional urethane (meth)acrylate, trifunctional polyester (meth)acrylate, tetrafunctional polyester (meth)acrylate, hexafunctional polyester (meth)acrylate, or combinations thereof.

Embodiment 9. An embodiment of any of Embodiments 1-8, wherein the second silane-treated aluminum oxide comprises calcined aluminum oxide, fused aluminum oxide, or a combination thereof.

Embodiment 10. An embodiment of any of Embodiments 1-9, wherein the second silane-treated aluminum oxide is at least 5% by weight of the topcoat.

Embodiment 11. An embodiment of any of Embodiments 1-10, wherein the first silane-treated aluminum oxide and the second silane-treated aluminum oxide are different silane-treated aluminum oxides.

Embodiment 12. An embodiment of any of Embodiments 1-10, wherein the first silane-treated aluminum oxide and the second silane-treated aluminum oxide are the same silane-treated aluminum oxide.

Embodiment 13. An embodiment of any of Embodiments 1-12 further comprising at least one: other polymer or polymer dispersion, solvent, biocide, mildewcide, algaecide, leveling agent, anti-settling agent, pH buffer, corrosion inhibitor, drier, anti-skinning agent, anti-cratering agent, anti-sag agent, heat stabilizer, UV absorber/inhibitor, HALS (hindered amine light stabilizer), antioxidant, wetting agent, flatteners and other inert pigments (such as titanium dioxide, dyes, clay, amorphous and surface treated silica, calcium carbonate, and the like, and combinations thereof), flow agent, catalyst, flow aid, anti-corrosive agent, adhesion promotor, toughening agent, or combinations thereof.

Embodiment 14. An embodiment of any of Embodiments 1-13 further comprising at least one additional primer coated onto the primer.

Embodiment 15. An embodiment of any of Embodiments 1-14 further comprising at least one additional topcoat coated onto the topcoat.

Embodiment 16. An embodiment of any of Embodiments 1-15 further comprising at least one clear coat coated on the topcoat or at least one additional topcoat.

Embodiment 17: The coatings system of any of claims 1-16, wherein the coatings system is cured by ultraviolet (UV), electron beam, infrared, heat, or combinations thereof.

Embodiment 18. A method of preparing the coatings system of any of Embodiments 1-17.

Embodiment 19. An article comprising the coatings system of any of Embodiments 1-17, wherein the coatings system is applied to at least one substrate.

Embodiment 20: An embodiment of Embodiment 19, wherein at least one substrate comprises wood, metal, concrete, paper, ceramic, plastic, composites, or combinations thereof.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A coatings system comprising:
a primer comprising a difunctional (meth)acrylate ester monomer, a first multifunctional (meth)acrylate, and a first silane-treated aluminum oxide; and
a topcoat comprising a difunctional (meth)acrylate ester monomer, a second multifunctional (meth)acrylate, and a second silane-treated aluminum oxide.

2. The coatings system of claim 1, wherein the difunctional (meth)acrylate ester monomer is 1,6-hexanediol diacrylate (HDDA), 1,6-hexanediol dimethacrylate (HDDMA), 1,4-butanediol dimethacrylate (BDDMA), 3-methyl-1,5-pentanediol diacrylate (MPDDA), 1,10-decanediol diacrylate (DDDA), tripropylene glycol diacrylate (TPGDA), dipropylene glycol diacrylate (DPGDA), triethylene glycol diacrylate (TEGDA), polyethylene glycol diacrylate, neopentyl glycol methacrylate (NPGMA), ethylene glycol dimethacrylate (EGDMA), diethylene glycol dimethacrylate (DEGMA), triethylene glycoldimethacrylate (TEGDMA), tetraethylene glycoldimethacrylate (T4EGDMA), hydroxy pivalic acid neopentyl glycol diacrylate (HPNDA), aliphatic difunctional urethane (meth)acrylate, aromatic difunctional urethane (meth)acrylate, difunctional polyester (meth)acrylate, or combinations thereof.

3. The coatings system of claim 1, wherein the first multifunctional (meth)acrylate is at least trifunctional.

4. The coatings system of claim 1, wherein the first multifunctional (meth)acrylate is dimethylolpropane triacrylate (TMPTA), pentaerythritol triacrylate (PETA), trimethylolpropane triacrylate (TMPTA), trimethylolpropane trimethacrylate (TMPTMA), pentaerythritol tetraacryate (PETTA), dipentaerythritol pentaacryate (DiPETA), dipentaerythritol hexaacryate (DPHA), aliphatic trifunctional urethane (meth)acrylate, aromatic trifunctional urethane (meth)acrylate, aliphatic tetrafunctional urethane (meth)acrylate, aromatic tetrafunctional urethane (meth)acrylate, aliphatic hexafunctional urethane (meth)acrylate, aromatic hexafunctional urethane (meth)acrylate, trifunctional polyester (meth)acrylate, tetrafunctional polyester (meth)acrylate, hexafunctional polyester (meth)acrylate, or combinations thereof.

5. The coatings system of claim 1, wherein the first silane-treated aluminum oxide comprises fused aluminum oxide, calcined aluminum oxide, or a combination thereof.

6. The coatings system of claim 1, wherein the first silane-treated aluminum oxide is at least 5% by weight of the primer.

7. The coatings system of claim 1, wherein the second multifunctional (meth)acrylate is at least trifunctional.

8. The coatings system of claim 1, wherein the second multifunctional (meth)acrylate is dimethylolpropane triacrylate (TMPTA), pentaerythritol triacrylate (PETA), trimethylolpropane triacrylate (TMPTA), trimethylolpropane trimethacrylate (TMPTMA), pentaerythritol tetraacryate (PETTA), dipentaerythritol pentaacryate (DiPETA), dipentaerythritol hexaacryate (DPHA), aliphatic trifunctional urethane (meth)acrylate, aromatic trifunctional urethane (meth)acrylate, aliphatic tetrafunctional urethane (meth)acrylate, aromatic tetrafunctional urethane (meth)acrylate, aliphatic hexafunctional urethane (meth)acrylate, aromatic hexafunctional urethane (meth)acrylate, trifunctional polyester (meth)acrylate, tetrafunctional polyester (meth)acrylate, hexafunctional polyester (meth)acrylate, or combinations thereof.

9. The coatings system of claim 1, wherein the second silane-treated aluminum oxide comprises calcined aluminum oxide, fused aluminum oxide, or a combination thereof.

10. The coatings system of claim 1, wherein the second silane-treated aluminum oxide is at least 1% by weight of the topcoat.

11. The coatings system of claim 1, wherein the first silane-treated aluminum oxide and the second silane-treated aluminum oxide are different silane-treated aluminum oxides.

12. The coatings system of claim 1, wherein the first silane-treated aluminum oxide and the second silane-treated aluminum oxide are the same silane-treated aluminum oxide.

13. The coatings system of claim 1 further comprising at least one: other polymer or polymer dispersion, solvent, biocide, mildewcide, algaecide, leveling agent, anti-settling agent, pH buffer, corrosion inhibitor, drier, anti-skinning agent, anti-cratering agent, anti-sag agent, heat stabilizer, UV absorber/inhibitor, HALS (hindered amine light stabilizer), antioxidant, wetting agent, flatteners and other inert pigments (such as titanium dioxide, dyes, clay, amorphous and surface treated silica, calcium carbonate, and the like, and combinations thereof), flow agent, catalyst, flow aid, anti-corrosive agent, adhesion promotor, toughening agent, or combinations thereof.

14. The coatings system of claim 1 further comprising at least one additional primer coated onto the primer.

15. The coatings system claim 1 further comprising at least one additional topcoat coated onto the topcoat.

16. The coatings system of claim 1 further comprising at least one clear coat coated on the topcoat or at least one additional topcoat.

17. The coatings system of claim 1, wherein the coatings system is cured by ultraviolet (UV), electron beam, infrared, heat, or combinations thereof.

18. A method of preparing the coatings system of claim 1.

19. An article comprising the coatings system of claim 1, wherein the coatings system is applied to at least one substrate.

20. The article of claim 19, wherein at least one substrate comprises wood, metal, concrete, paper, ceramic, plastic, composites, or combinations thereof.
